(19) United States
(12) Patent Application Publication
(10) Pub. No.: US 2026/0071815 A1
(43) Pub. Date: Mar. 12, 2026

(54) FACILITY AND METHOD FOR DRYING ELECTRODE

(71) Applicant: SK ON CO., LTD., Seoul (KR)

(72) Inventor: Song Hyeon KIM, Daejeon (KR)

(21) Appl. No.: 19/310,953

(22) Filed: Aug. 27, 2025

(30) Foreign Application Priority Data
Sep. 10, 2024 (KR) 10-2024-0122803

(51) Int. Cl. F26B 13/18; F26B 3/20; F26B 3/30

(52) U.S. Cl. CPC F26B 13/183; F26B 3/20; F26B 3/30

(57) ABSTRACT

Facility and method for drying electrode are disclosed. The electrode drying facility according to an embodiment of this disclosure is transporting and drying an electrode extended in the longitudinal direction and comprises a heating roller unit including a heating roller that forms a roller shape and transports the electrode and heats the electrode, a heater unit heating the electrode drawn from the heating roller unit, an electrode cooling equipment cooling the electrode drawn from the heater unit, wherein the heater unit irradiates a laser beam containing infrared rays to the electrode.

### CROSS-REFERENCE TO RELATED APPLICATION AND CLAIM OF PRIORITY

This application claims priority to Korean Patent Application No. 10-2024-0122803 filed on September 10, 2024 in the Korean Intellectual Property Office (KIPO), the entire disclosure of which is incorporated by reference herein.

### TECHNICAL FIELD

The present disclosure relates to facility and method for drying electrode.

### BACKGROUND

The electrode used in the secondary battery may include a metal film and a coating agent applied to the metal film. Since the coating agent includes an active material, moisture contained in the electrode may affect the performance of the secondary battery. Therefore, equipment and methods for effectively drying the electrode have been studied.

### SUMMARY

It may be an object of the present disclosure to provide an electrode drying facility and method for preliminarily heating an electrode.

An object of the present disclosure may be to provide an electrode drying facility and method for removing foreign substances attached to an electrode before cooling the heated electrode.

An object of the present disclosure may be to provide an electrode drying facility and method that shields a portion of infrared rays irradiated onto the electrode.

An electrode drying facility according to an embodiment of this disclosure is for transporting and drying an electrode extended in the longitudinal direction. The electrode comprises a heating roller unit including a heating roller that forms a roller shape and transports the electrode and heats the electrode, a heater unit heating the electrode drawn from the heating roller unit, an electrode cooling equipment cooling the electrode drawn from the heater unit. The heater unit may irradiate a laser beam containing infrared rays to the electrode.

The heater unit may include a first heater assembly heating the electrode drawn from the heating roller, and a second heater assembly heating the electrode drawn from the first heater assembly according to a temperature of the electrode drawn from the first heater assembly.

The electrode drying facility may comprise a sensor unit measuring the temperature of the electrode and a control unit. The sensor unit may measure the temperature of the electrode drawn from the first heater assembly, and the control unit may control a power of the second heater assembly according to the temperature of the electrode.

The second heater assembly may include a heater frame, a heater bracket coupled to the heater frame and a heater coupled to the heater bracket. The heater may include a heater body coupled to the heater bracket and a plurality of heating segments coupled to the heater body and arranged in a width direction of the electrode and irradiating infrared rays.

The sensor unit may measure the temperature distributed in the width direction of the electrode. The control unit may control the plurality of heating segments according to the temperature distributed in the width direction of the electrode.

The heater bracket may be movably coupled to the heater frame in at least one of the longitudinal direction or the width direction.

The electrode drying facility may comprise a heated electrode transport unit transporting the electrode drawn from the heater unit. The heated electrode transport unit may include a heated electrode transport frame, a heated electrode transport roller rotatably coupled to the heated electrode transport frame and being in contact with the electrode, and a heated electrode coolant supply portion supplying a coolant to the heated electrode transport roller.

The electrode drying facility may comprise an electrode cleaning equipment that removes foreign substances attached to the electrode drawn from the heater unit and transfers the electrode to the electrode cooling equipment.

The electrode cleaning equipment may include a discharge device removing at least a portion of the static electricity formed on the electrode and a suction device removing at least a portion of the foreign substances from the electrode.

The suction device may include a suction nozzle facing the electrode, a suction body forming a hollow portion and an ultrasonic generator irradiating an ultrasonic wave on the electrode. An end of the suction body may be connected to the suction nozzle.

The heater unit may include a heater frame, a heater bracket coupled to the heater frame, a heater coupled to the heater bracket and a duct module positioned adjacent to the electrode. The duct module may include a blower segment blowing a gas and a exhaust segment facing the blower segment and sucking the gas.

The heater unit may include, a right heater and a left heater which face the electrode placed between the right heater and the left heater, and a shield frame placed between the right heater and the left heater.

The the shield frame may include a front shield frame and a rear shield frame spaced apart from each other. The electrode may be placed between the front shield frame and the rear shield frame. The front shield frame may face a side of the electrode. The rear shield frame may face the other side of the electrode.

An electrode drying method according to an embodiment of this disclosure is for transporting and drying an electrode extended in a longitudinal direction. The method comprises heating the electrode, cleaning the electrode by removing foreign substances from the heated electrode and cooling the electrode.

Heating the electrode may include heating the electrode firstly, acquiring information on a temperature of the electrode, and heating the electrode secondly according to the information on the temperature of the electrode.

The information on the temperature of the electrode may include a temperature distribution in a width direction of the electrode.

Heating the electrode may include preheating the electrode before heating the electrode firstly.

The temperature of the electrode after preheating the electrode before heating the electrode firstly may be lower than the temperature of the electrode after heating the electrode firstly before heating the electrode secondly.

Preheating the electrode may be performed through heat conduction, heating the electrode firstly may be performed through heat radiation, and heating the electrode secondly may be performed through the heat radiation.

Cleaning the electrode may include removing at least a portion of static electricity formed on the electrode, irradiating an ultrasonic wave on the electrode, and sucking the foreign substances.

According to an embodiment of the present disclosure, an electrode drying facility and method for preliminarily heating an electrode can be provided.

According to an embodiment of the present disclosure, an electrode drying facility and method for removing foreign substances attached to an electrode before cooling the heated electrode can be provided.

According to an embodiment of the present disclosure, an electrode drying facility and method for shielding a portion of infrared rays irradiated to an electrode can be provided.

The electrode drying facility and method of the present disclosure can be used in the manufacture of eco-friendly electric vehicles, hybrid vehicles, etc. to prevent climate change by suppressing air pollution and greenhouse gas emissions.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIG. 1 is a drawing which shows an electrode.

FIG. 2 is a block diagram which shows an electrode drying facility according to an embodiment of the present disclosure.

FIG. 3 is a flowchart illustrating an electrode drying method according to an embodiment of the present disclosure.

FIG. 4 is a flowchart which shows the electrode heating step.

FIG. 5 is a drawing which shows a heating roller unit according to an embodiment of the present disclosure.

FIG. 6 is a drawing which shows a heater unit according to an embodiment of the present disclosure.

FIG. 7 is a drawing which shows the heater illustrated in FIG. 6.

FIG. 8 is a drawing which shows the duct module illustrated in FIG. 6.

FIG. 9 is a drawing showing a heated electrode transport unit.

FIG. 10 is a drawing which shows an electrode cleaning equipment and an electrode cooling equipment according to an embodiment of the present disclosure.

FIG. 11 is a drawing which shows a cross-section of a part of the electrode drying facility shown in FIG. 10.

### DETAILED DESCRIPTION OF THE EMBODIMENTS

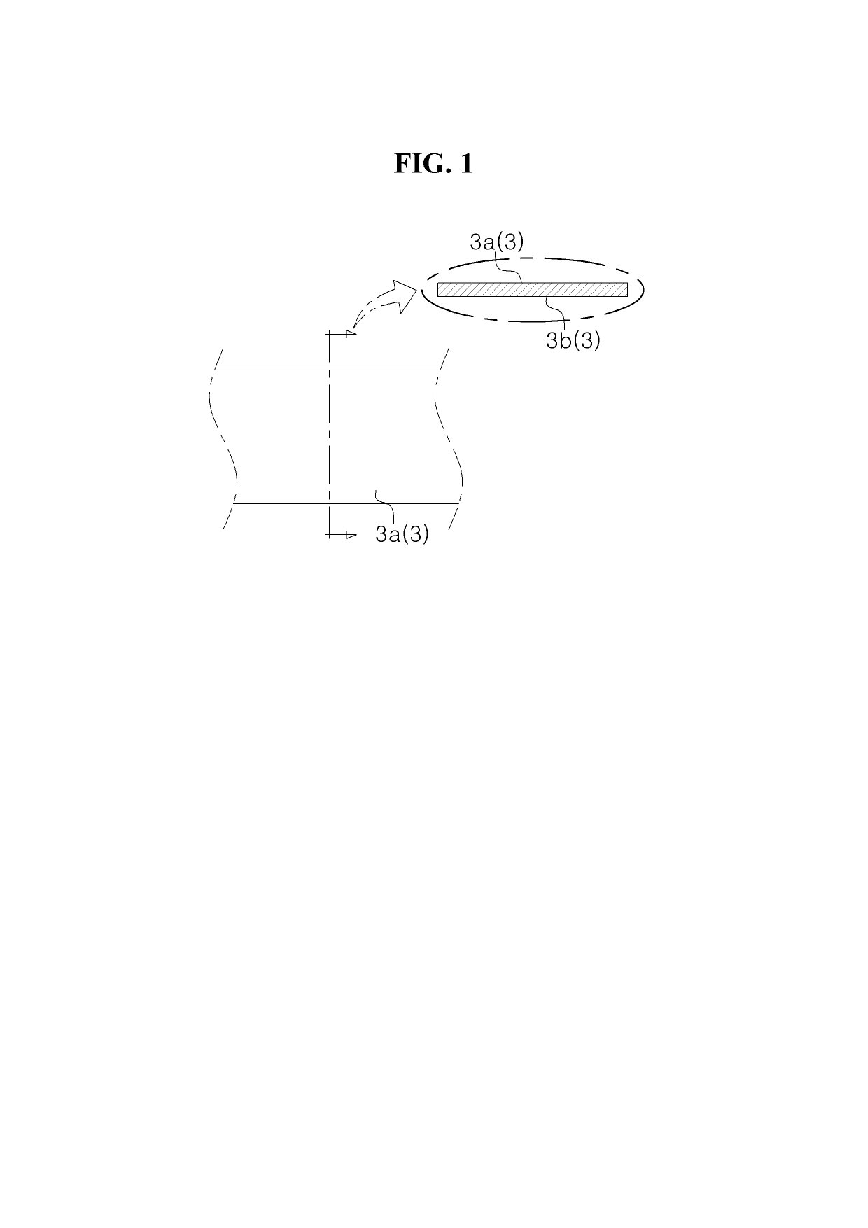

Hereinafter, the present disclosure will be described in detail with reference to FIGS. 1 to 11. However, these are merely exemplary and the present disclosure is not limited to the specific embodiments described as exemplary.

An XYZ coordinate system may be used in this specification. The XYZ coordinate system may be a Cartesian coordinate system.

For example, the Z-axis can be parallel to the up-down direction. For example, a positive Z-axis direction can represent an upward direction. For example, a negative Z-axis direction can represent a downward direction.

For example, the X-axis can be parallel to the forward/backward direction. For example, the positive X-axis direction can represent the forward direction. For example, the negative X-axis direction can represent the rearward direction.

For example, the Y-axis can be aligned with the left-right direction. For example, the positive Y-axis can represent the left direction. For example, the negative Y-axis can represent the right direction.

FIG. 1 is a drawing which shows an electrode.

Referring to FIG. 1, the electrode 3 can be used in a secondary battery. The electrode 3 may form two surfaces. For example, the first electrode surface 3a may be a surface of the electrode 3. For example, the second electrode surface 3b may be another surface of the electrode 3 which is opposite the first electrode surface 3a.

The electrode 3 may include a metal film and a coating agent applied to the metal film. The coating agent may include an active material, a binder, and an adhesive. The coating agent may contain moisture. The content of moisture contained in the coating agent may affect the performance or the quality of the electrode 3. Therefore, it may be necessary to dry the electrode 3.

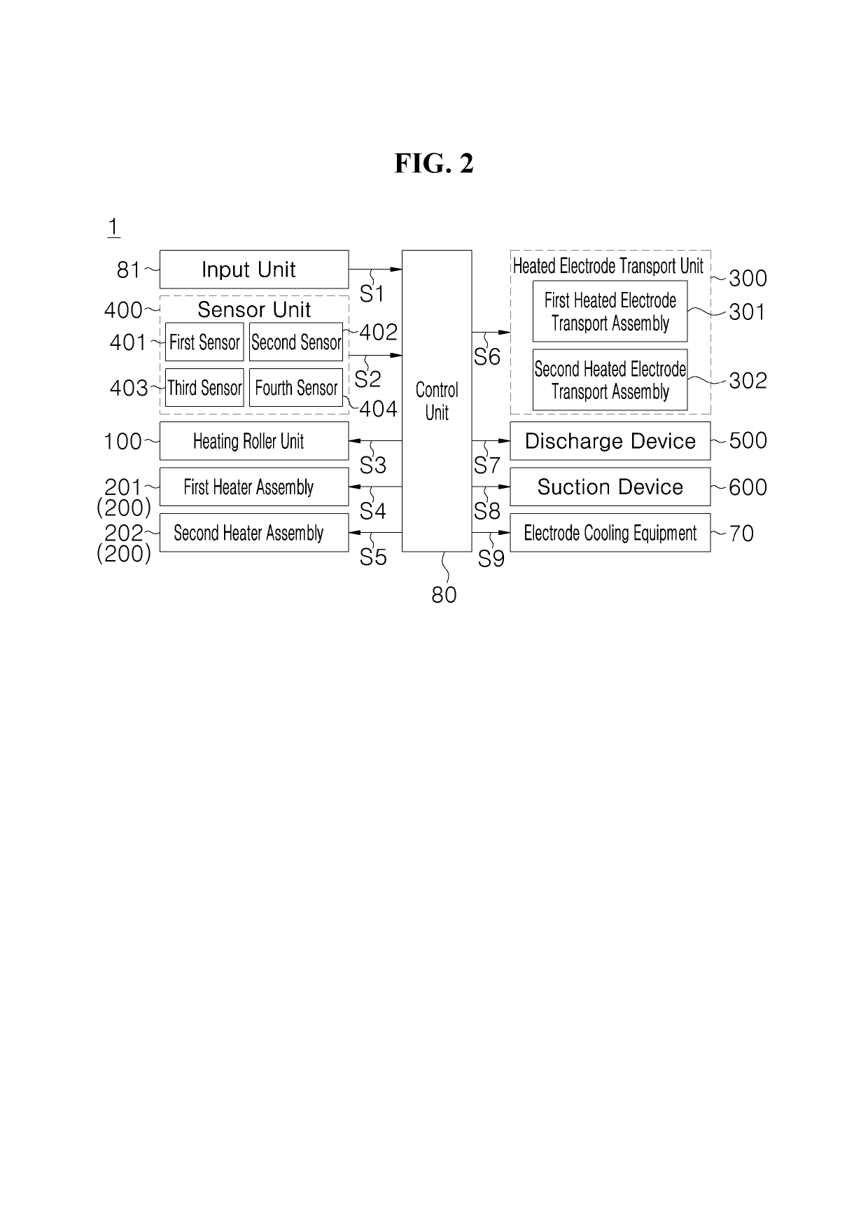

FIG. 2 is a block diagram which shows an electrode drying facility according to an embodiment of the present disclosure.

Referring to FIGS. 1 and 2, the electrode drying facility 1 may include a control unit 80. The control unit 80 may perform calculations. The control unit 80 may process signals. For example, the control unit 80 may transmit and receive signals. For example, the control unit 80 may be implemented through at least one of a computer, a processor, an electric circuit, or a PCB (printed circuit board).

The control unit 80 can generate output signals S3, S4, S5, S6, S7, S8, S9 based on input signals S1, S2. The input signals S1, S2 may include or mean at least one of the first signal S1 or the second signal S2.

The output signal may include or mean at least one of a third signal S3, a fourth signal S4, a fifth signal S5, a sixth signal S6, a seventh signal S7, an eighth signal S8, or a ninth signal S9.

The electrode drying facility 1 may include an input unit 81. The input unit 81 may obtain input from a user or the like. The input unit 81 may generate a first signal S1 and transmit the first signal S1 to the control unit 80. The first signal S1 may include information regarding an operation command of the electrode drying facility 1.

The electrode drying facility 1 may include an electrode heating equipment 10. The electrode heating equipment 10 may include a heating roller unit 100. The heating roller unit 100 may transport the electrode 3.

The heating roller unit 100 can transfer heat to the electrode 3. For example, the heating roller unit 100 can transfer heat to the electrode 3 through heat conduction.

The electrode heating equipment 10 may include a heater unit 200. For example, the electrode heating equipment 10 may include a first heater assembly 201 and a second heater assembly 202. The heater unit 200 may include or mean at least one of the first heater assembly 201 or the second heater assembly 202.

The heater unit 200 can apply heat to the electrode 3. For example, the heater unit 200 can transfer heat to the electrode 3 through heat radiation. For example, the heater unit 200 may include a laser that emits infrared rays.

The electrode heating device 10 may include a heated electrode transport unit 300. The heated electrode transport unit 300 may transport the electrode 3 heated by the heater unit 200.

The heated electrode transport unit 300 may be provided in multiples. For example, the electrode heating device 10 may include a first heated electrode transport assembly 301 and a second heated electrode transport assembly 302. The heated electrode transport unit 300 may include or mean at least one of the first heated electrode transport assembly 301 or the second heated electrode transport assembly 302.

The coolant injected into the heated electrode transport unit 300 can suppress a temperature rise of the heated electrode transport unit 300. The coolant injected into the heated electrode transport unit 300 can be, for example, water. By suppressing the temperature rise of the heated electrode transport unit 300, an atmospheric temperature rise of the electrode drying facility 1 can be suppressed.

The electrode heating equipment 10 may include a sensor unit 400. For example, the sensor unit 400 may include a temperature sensor. The sensor unit 400 may measure the temperature of the electrode 3. For example, the sensor unit 400 may measure the temperature of a plurality of points of the electrode 3.

For example, the plurality of points of the electrode 3 measured by the sensor unit 400 may be arranged in the width direction of the electrode 3. For example, the longitudinal direction of the electrode 3 may be the direction in which the electrode 3 is transported. The width direction of the electrode 3 may intersect the longitudinal direction of the electrode 3.

The sensor unit 400 can measure the temperature of the electrode 3 heated by the first heater assembly 201. For example, the sensor unit 400 can measure the temperature distribution in the width direction of the electrode 3 heated by the first heater assembly 201.

The sensor unit 400 can generate a second signal S2 and transmit the second signal S2 to the control unit 80. The second signal S2 may include temperature information of the electrode 3 heated by the first heater assembly 201.

The control unit 80 can generate a third signal S3 based on the input signals S1, S2. The third signal S3 can be transmitted to the heating roller unit 100. The heating roller unit 100 may operate according to the third signal S3.

The third signal S3 may include information regarding an operation command of the heating roller unit 100. For example, the third signal S3 may include information regarding at least one of the rotation speed or temperature of the heating roller unit 100.

The control unit 80 can generate a fourth signal S4 based on the input signals S1, S2. The fourth signal S4 can be transmitted to the first heater assembly 201. The first heater assembly 201 may operate according to the fourth signal S4.

For example, the fourth signal S4 may include information regarding an operating command of the first heater assembly 201. For example, the fourth signal S4 may include information regarding at least one of the overall power or power distribution of the first heater assembly 201.

The control unit 80 can generate a fifth signal S5 based on the input signals S1, S2 and transmit the fifth signal S5 to the second heater assembly 202. The second heater assembly 202 may operate according to the fifth signal S5.

For example, the fifth signal S5 may include information regarding an operating command of the second heater assembly 202. For example, the fifth signal S5 may include information regarding at least one of the overall power or power distribution of the second heater assembly 202.

For example, the control unit 80 can extract information on temperature distribution of the electrode 3 heated by the first heater assembly 201 from the second signal S2. For example, the control unit 80 can control the second heater assembly 202 to ensure that the temperature of the electrode 3 is distributed more uniformly.

The control unit 80 can generate a sixth signal S6 based on the input signals S1, S2. The control unit 80 can transmit the sixth signal S6 to the heated electrode transport unit 300. The heated electrode transport unit 300 may operate according to the sixth signal S6.

The sixth signal S6 may include information regarding an operation command of the heated electrode transport unit 300. For example, the sixth signal S6 may include information regarding at least one of the rotation speed or temperature of the heated electrode transport unit 300.

The electrode drying facility 1 may include an electrode cleaning equipment 50. The electrode cleaning equipment 50 may include a discharge device 500. When the electrode 3 is heated and dried, static electricity may be formed on the electrode 3.

When static electricity is formed on the electrode 3, the probability of foreign substances attaching to the electrode 3 may increase. When foreign substances attach to the electrode 3, the quality of the electrode 3 may deteriorate.

The discharge device 500 can remove at least a portion of the static electricity formed on the electrode 3. When at least a portion of the static electricity formed on the electrode 3 is removed, the bonding force between the electrode 3 and the foreign substance can be decreased.

The control unit 80 can generate a seventh signal S7 based on the input signals S1, S2. The seventh signal S7 can be transmitted to the discharge device 500. The discharge device 500 may operate according to the seventh signal S7.

The seventh signal S7 may include information regarding an operation command of the discharge device 500. For example, the seventh signal S7 may include information regarding the power of the discharge device (500).

The electrode cleaning equipment 50 may include a suction device 600. The suction device 600 may suck up at least a portion of foreign matter attached to the electrode 3.

The control unit 80 can generate an eighth signal S8 based on the input signals S1, S2. The eighth signal S8 can be transmitted to the suction device 600. The suction device 600 may operate according to the eighth signal S8.

The eighth signal S8 may include information regarding an operation command of the suction device 600. For example, the eighth signal S8 may include information regarding the power of the suction device 600.

The temperature of the dried electrode 3 may be higher than room temperature. When the electrode 3 of relatively high temperature is wound to form a roll, physical or/and chemical bonding may occur between the electrodes 3 as the electrodes 3 are cooled.

Therefore, the dried electrode 3 needs to be cooled to room temperature before being wound to form the roll. The electrode drying facility 1 may include an electrode cooling equipment 70. The electrode cooling equipment 70 can lower the temperature of the electrode 3 from which foreign substances have been removed by the electrode cleaning equipment 50.

The electrode cooling equipment 70 may include a roller. The electrode cooling equipment 70 may lower the temperature of the electrode 3 through heat transfer. For example, the temperature of the electrode cooling equipment 70 may be lower than the temperature of the electrode 3 in contact with the electrode cooling equipment 70.

For example, a coolant may be injected into the electrode cooling equipment 70. The coolant injected into the electrode cooling equipment 70 may include, for example, oil. For example, the temperature of the oil injected into the electrode cooling equipment 70 may be lower than the temperature of the electrode 3 in contact with the electrode cooling equipment 70.

The control unit 80 can generate a ninth signal S9 based on the input signals S1, S2. The ninth signal S9 can be transmitted to the electrode cooling equipment 70. The electrode cooling equipment 70 may operate according to the ninth signal S9. For example, the ninth signal S9 can include information about the set temperature of the electrode cooling equipment 70.

The sensor unit 400 may be provided in plurality. For example, the sensor unit 400 may include a first sensor 401 that measures the temperature of a portion of the electrode 3 that is heated by the heating roller unit 100 and before being heated by the first heater assembly 201. The temperature information acquired by the first sensor 401 may be used to generate the fourth signal S4.

For example, the sensor unit 400 may include a second sensor 402 that measures the temperature of a portion of the electrode 3 that is heated by the first heater assembly 201 and before being heated by the second heater assembly 202. Temperature information acquired by the second sensor 402 may be used to generate the fifth signal S5.

For example, the sensor unit 400 may include a third sensor 403 that measures the temperature of a portion of the electrode 3 that is heated by the second heater assembly 202 and before being cooled by the electrode cooling equipment 70.

For example, the sensor unit 400 may include a fourth sensor 404 that measures the temperature of a portion of the electrode 3 cooled by the electrode cooling device 70. The temperature information acquired by the third sensor 403 and the temperature information acquired by the fourth sensor 404 may be used to generate the ninth signal S9.

The heating, cleaning and cooling processes of the electrode 3 can be examined. For example, the electrode 3 can be pre-heated. By pre-heating the electrode 3 before the electrode 3 is heated by the heater unit 200, a rapid temperature rise of the electrode 3 can be suppressed.

For example, the heating roller unit 100 can heat the electrode 3 while transporting the electrode 3. The first sensor 401 can measure the temperature of the electrode 3 heated by the heating roller unit 100.

For example, the first heater assembly 201 can heat the electrode 3 heated by the heating roller unit 100. The electrode 3 heated by the first heater assembly 201 can be transported to the first heated electrode transport assembly 301.

The first heated electrode transport assembly 301 can transport the heated electrode 3. For example, the electrode 3 heated by the first heater assembly 201 can be transported to the second heater assembly 202 via the first heated electrode transport assembly 301.

The second sensor 402 can measure the temperature of the electrode 3 entering the second heater assembly 202. The control unit 80 can extract information on temperature and temperature distribution of the electrode 3 entering the second heater assembly 202 based on the temperature measurement value obtained by the second sensor 402.

For example, the control unit 80 can control the second heater assembly 202 based on the temperature measurement value acquired by the second sensor 402. For example, the second heater assembly 202 can control at least one of the overall temperature or temperature distribution of the electrode 3 by being controlled by the control unit 80.

The electrode 3 drawn from the second heater assembly 202 can be transferred to the second heated electrode transport assembly 302. The second heated electrode transport assembly 302 can transfer the electrode 3 drawn from the second heater assembly 202 to the discharge device 500.

The discharge device 500 can remove at least a portion of the static electricity formed on the electrode 3. The electrode 3 that has passed through the discharge device 500 can be transferred to the suction device 600. The suction device 600 can remove at least a portion of the foreign matter attached to the electrode 3.

The electrode 3 drawn from the electrode cleaning equipment 50 can be transferred to the electrode cooling equipment 70. The electrode cooling equipment 70 can cool the electrode 3 through heat transfer while being contact with the electrode 3.

The third sensor 403 can measure the temperature of the electrode 3 entering the electrode cooling equipment 70. The fourth sensor 404 can measure the temperature of the electrode 3 drawn from the electrode cooling equipment 70.

The temperature measurement values obtained by the third sensor 403 and the fourth sensor 404 can become the basis for generating the ninth signal S9. As a result, the electrode cooling equipment 70) can decrease the temperature of the electrode 3 to a set temperature. The electrode 3 drawn from the electrode cooling equipment 70 can be wound and formed into a roll.

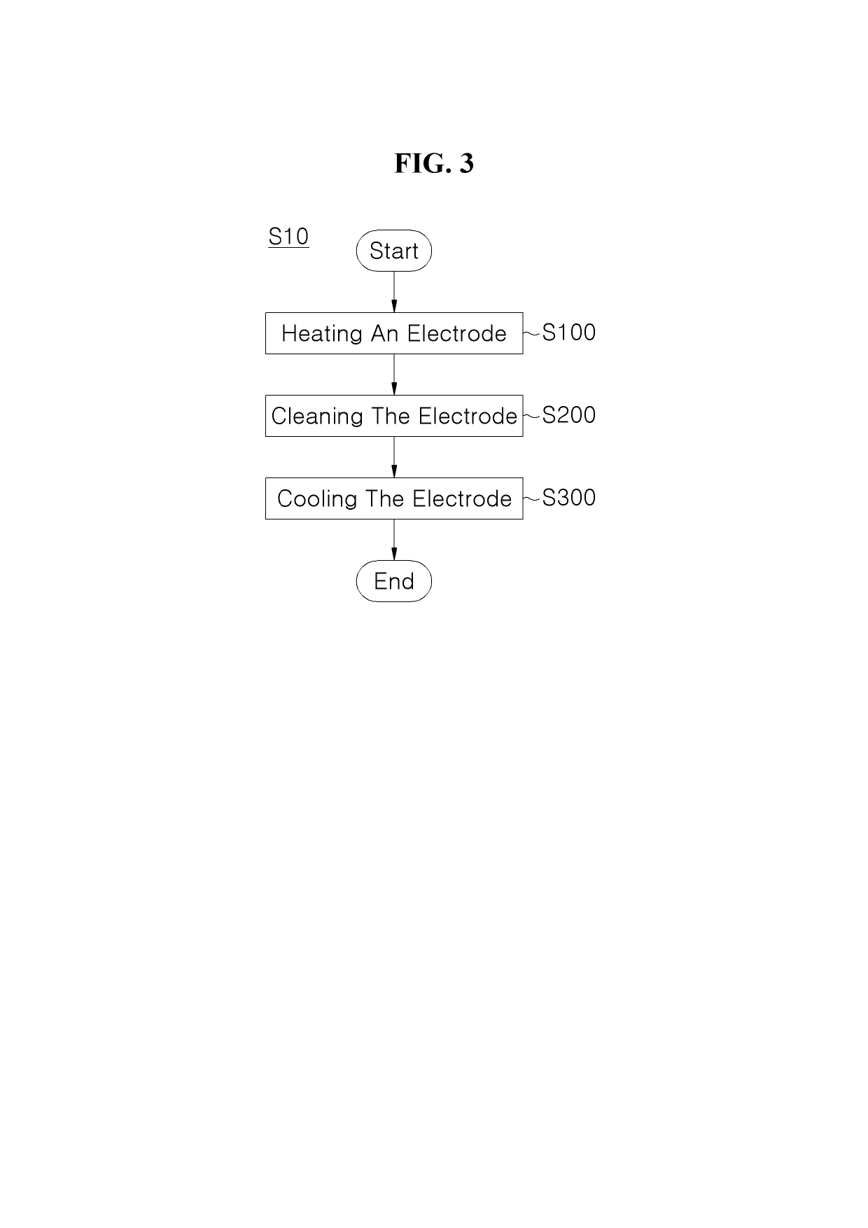

FIG. 3 is a flowchart illustrating an electrode drying method according to an embodiment of the present disclosure.

Referring to FIGS. 1 to 3, the electrode drying method S10 may include a step S100 of heating an electrode. In this step S100, the electrode drying facility 1 may heat the electrode 3. When the electrode 3 is heated, the temperature of the electrode 3 may increase. When the temperature of the electrode 3 increases, the electrode 3 may be dried. This step S100 may be referred to as electrode heating step.

The electrode drying method S10 may include a step S200 of cleaning the electrode 3. During the process of drying the electrode 3, foreign substances may be attached to the electrode 3. In this step S200, the electrode cleaning equipment 50 may remove at least a portion of the foreign substances attached to the electrode 3 from the electrode 3.

The electrode drying method S10 may include a step S300 of cooling the electrode. During the process of drying the electrode 3, the temperature of the electrode 3 may increase. Before the electrode 3 is wound into a roll, the temperature of the electrode 3 needs to decrease. In this step S300, the electrode cooling device 70 may decrease the temperature of the electrode 3.

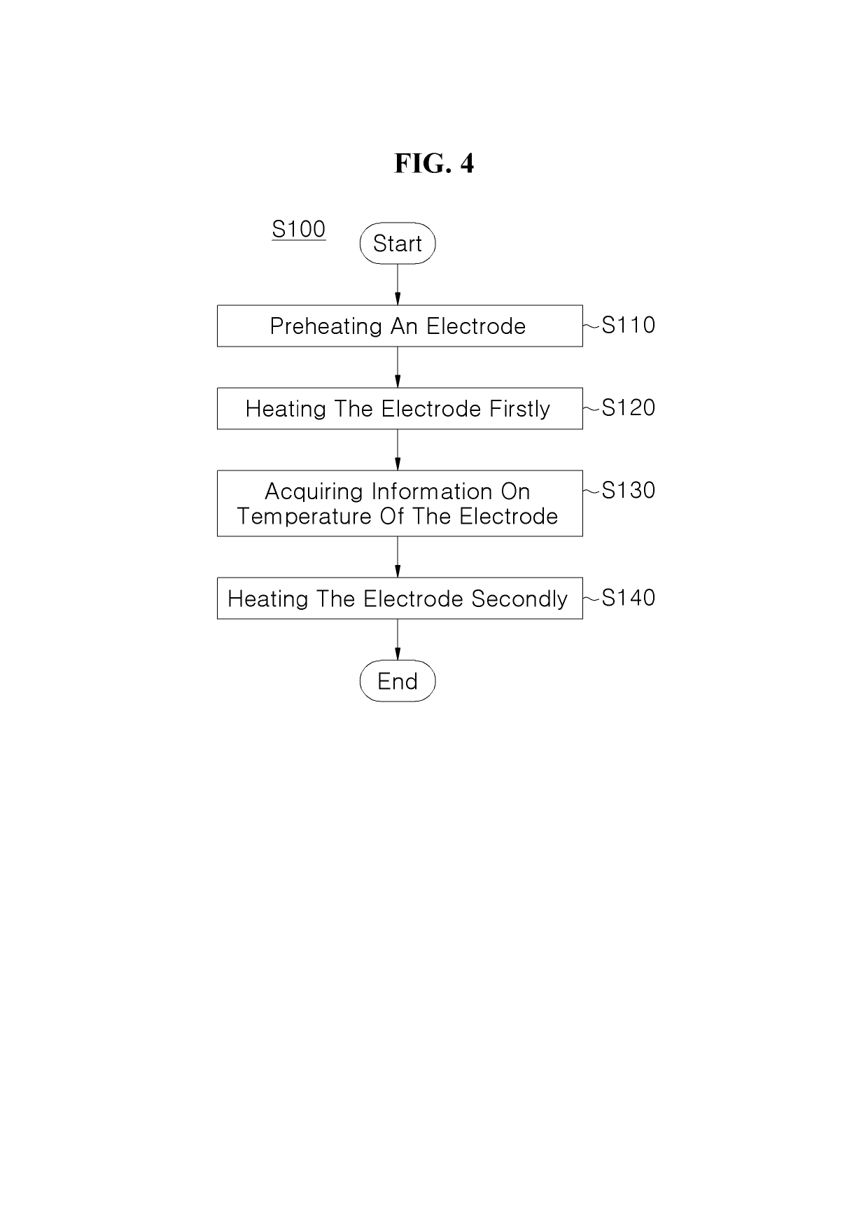

FIG. 4 is a flowchart which shows the electrode heating step.

Referring to FIGS. 1 to 4, the electrode heating step S100 may include step S110 of preheating the electrode 3. In this step S110, the electrode 3 may be preliminarily heated.

For example, in this step S110, the heating roller unit 100 can heat the electrode 3 while transporting the electrode 3. For example, in this step S110, heat can be transferred from the heating roller unit 100 to the electrode 3, so that the temperature of the electrode 3 can rise.

For example, before this step S110, the temperature of the electrode 3 may be room temperature. The room temperature may be, for example, 15 to 30 degrees Celsius. For example, in this step S110, the temperature of the electrode 3 may rise to 40 to 60 degrees Celsius.

The electrode heating step S100 may include a step S120 of heating the electrode 3 firstly. In this step S120, for example, the first heater assembly 201 may apply heat to the electrode 3. For example, the first heater assembly 201 may transmit electromagnetic waves including infrared rays to the electrode 3. This step 120 may be referred to as first electrode heating step.

The electrode heating step S100 may include a step S130 of acquiring information on temperature of the electrode 3. In this step S130, the sensor unit 400 may measure the temperature of the electrode 3.

For example, in this step S130, the sensor unit 400 can obtain information on temperature distribution of the electrode 3. The temperature distribution of the electrode 3 may be a temperature distribution of the electrode 3 in the width direction of the electrode 3.

The electrode heating step S100 may a step S140 of heating the electrode 3 secondly. In at least one of this step S140 or the previous step S130, the control unit 80 may generate the fifth signal S5 based on the input signals S1, S2.

In this step S140, the second heater assembly 202 can heat the electrode 3 according to the fifth signal S5. The fifth signal S5 may include information regarding the power distribution of the second heater assembly 202. This step S140 may be referred to as second electrode heating step.

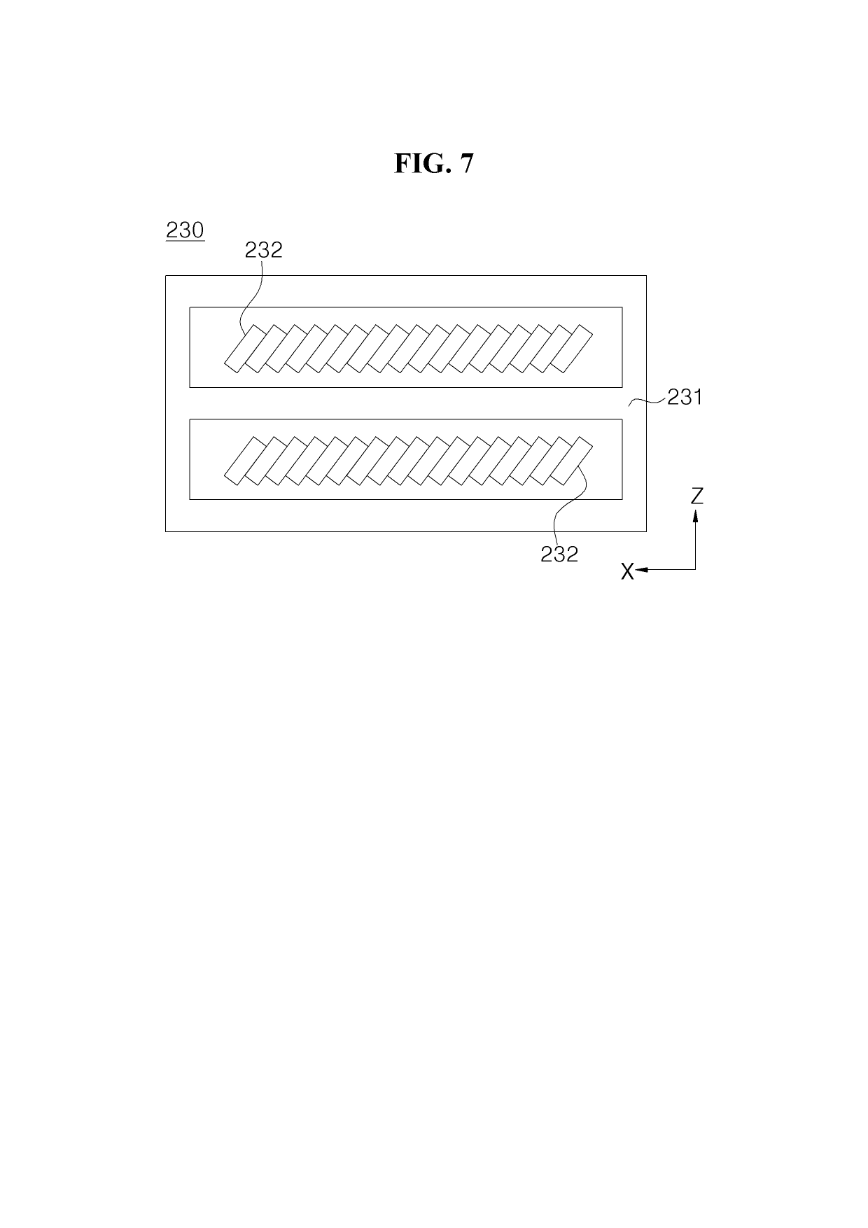

For example, the control unit 80 can set the power distribution of a plurality of heating segments 232 (see FIG. 7) of the second heater assembly 202 according to the temperature distribution of the electrode 3 heated in the first electrode heating step S120.

For example, the power of the heating segment 232 (see FIG. 7) corresponding to a point having a relatively low temperature among the electrodes 3 can be set relatively high.

For example, the power of the heating segment 232 (see FIG. 7) corresponding to a point having a relatively high temperature among the electrodes 3 can be set relatively low. As a result, the temperature distribution of the electrodes 3 can become more uniform.

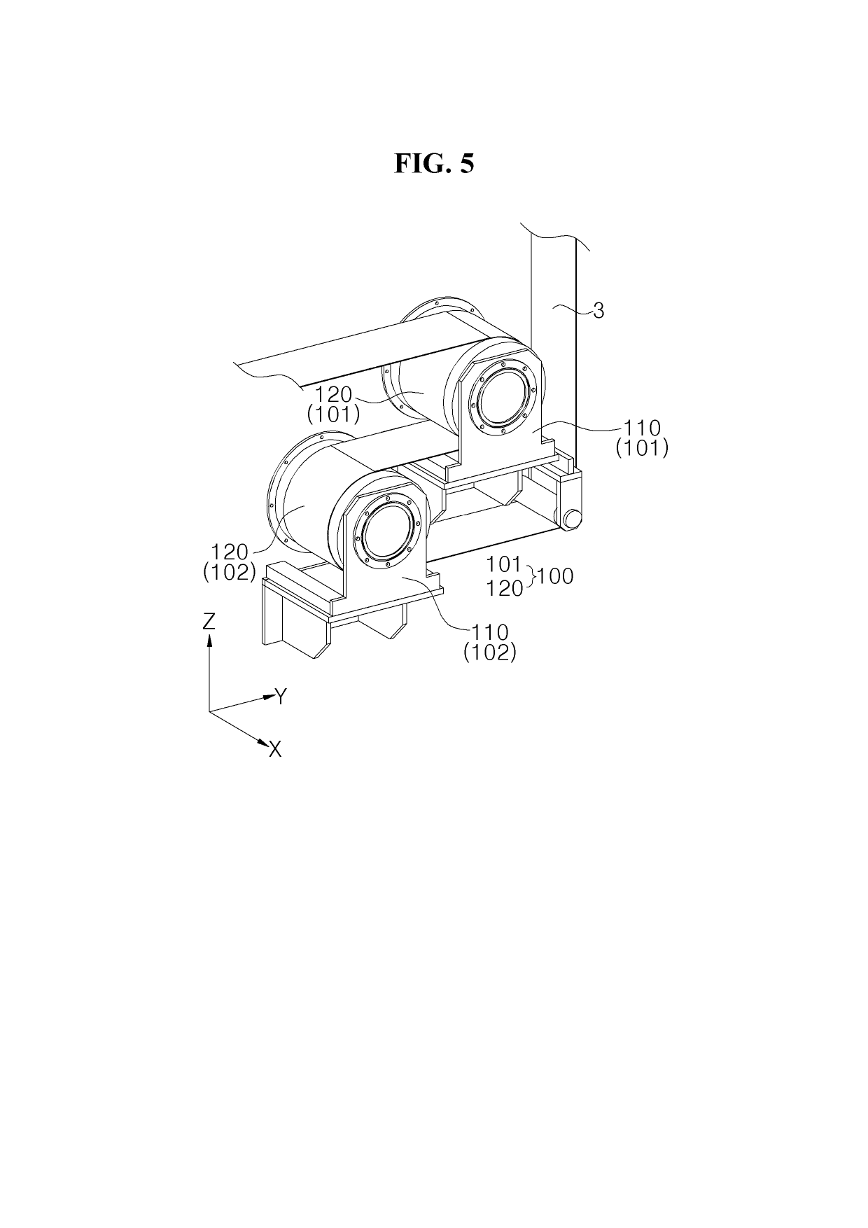

FIG. 5 is a drawing which shows a heating roller unit according to an embodiment of the present disclosure.

Referring to FIG. 5, the electrode heating equipment 10 (see FIG. 2) may include a heating roller unit 100. A plurality of heating roller units 100 may be provided.

For example, the electrode heating equipment 10 (see FIG. 2) may include a first heating roller module 101 and a second heating roller module 102. The heating roller unit 100 may include or mean at least one of the first heating roller module 101 or the second heating roller module 102.

The heating roller unit 100 may include a heating roller frame 110. The heating roller frame 110 may be fixed to an external fixture.

The heating roller unit 100 may include a heating roller 120. The heating roller 120 may be rotatably coupled to the heating roller frame 110. The heating roller 120 may contact the electrode 3. For example, the heating roller 120 may transport the electrode 3.

The heating roller 120 can be heated. For example, the heating roller unit 100 can include a member (not shown) that heats the heating roller 120. The heated heating roller 120 can heat the electrode 3 through heat transfer. For example, the temperature of the heating roller 120 can be higher than the temperature of the electrode 3 that comes into contact with the heating roller 120.

A member (not shown) for heating the heating roller 120 can heat the heating roller 120 by, for example, applying power. The member (not shown) for heating the heating roller 120 can heat the heating roller 120 by, for example, induction heating.

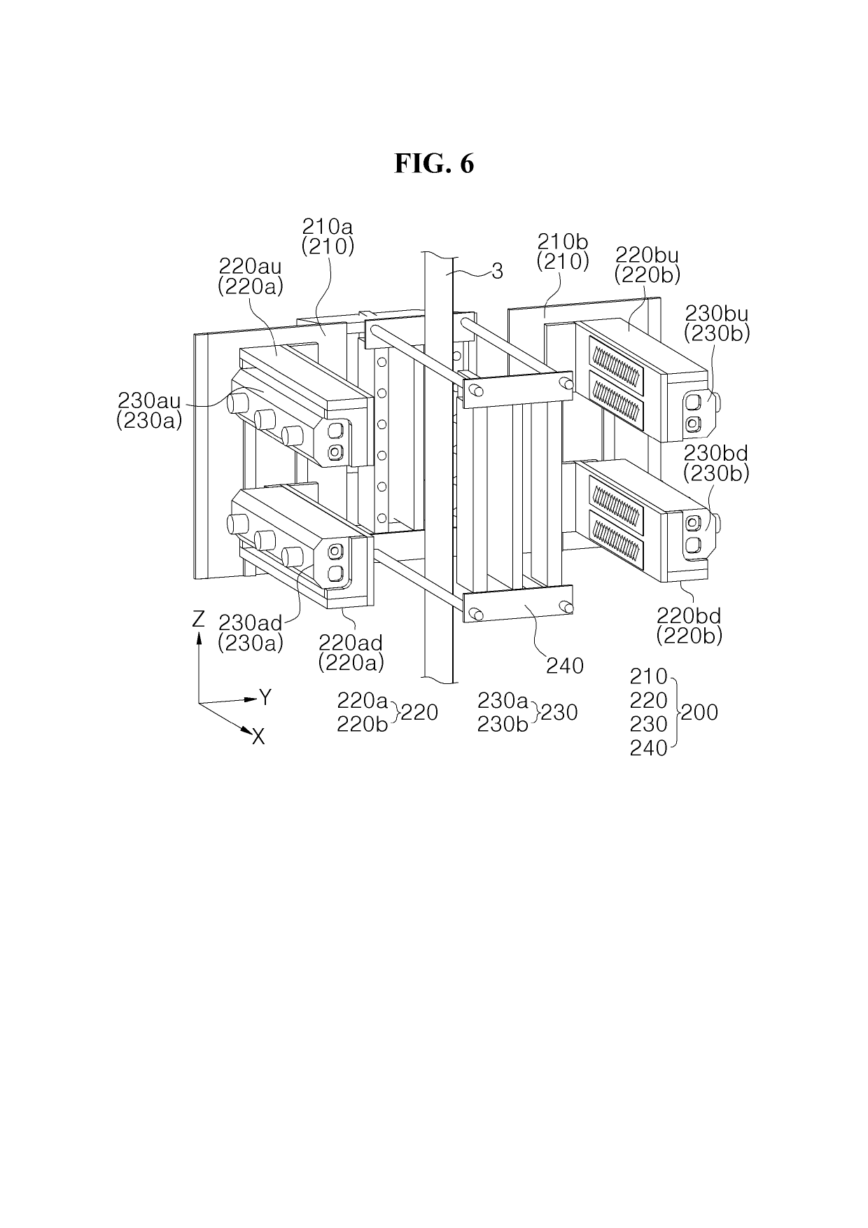

FIG. 6 is a drawing which shows a heater unit according to an embodiment of the present disclosure.

Referring to FIG. 6, the electrode 3 can be moved in the up-down direction. For example, the first electrode surface 3a (see FIG. 1) of the electrode 3 can face the right side. For example, the second electrode surface 3b (see FIG. 1) of the electrode 3 can face the left side.

The heater unit 200 may include a heater frame 210. The heater frame 210 may be fixed to a fixture. The heater frame 210 may be provided in plurality, for example.

For example, the heater unit 200 may include a right heater frame 210a and a left heater frame 210b. The heater frame 210 may include or mean at least one of the right heater frame 210a or the left heater frame 210b. For example, the electrode 3 may pass between the right heater frame 210a and the left heater frame (210b).

The heater unit 200 may include a heater bracket 220. The heater bracket 220 may be connected to, fixed to, or installed on the heater frame 210. For example, the heater bracket 220 may be movably coupled to the heater frame 210.

For example, the heater bracket 220 may be movably coupled to the heater frame 210 in the moving direction of the electrode 3. The moving direction of the electrode 3 may be the longitudinal direction of the electrode 3. For example, in FIG. 6, the moving direction of the electrode 3 may be the Z-axis direction. The moving direction of the electrode 3 may be the direction in which the electrode 3 is transported.

For example, the heater bracket 220 may be movably coupled to the heater frame 210 in the width direction of the electrode 3. The width direction of the electrode 3 may intersect the longitudinal direction of the electrode 3. For example, the width direction may be a front-back direction. For example, the width direction may be parallel to the X-axis direction.

The longitudinal direction and width direction of the electrode 3 can form a surface of the electrode 3. The surface of the electrode 3 can be the first electrode surface 3a (see FIG. 1) or/and the second electrode surface 3b (see FIG. 1).

In FIGS. 6 to 8, the width direction of the electrode 3 may be the width direction of the heater unit 200. For example, the width direction of the electrode 3 may be parallel to the X-axis direction.

In FIGS. 6 to 8, the longitudinal direction of the electrode 3 may be the longitudinal direction of the heater unit 200. For example, the longitudinal direction of the electrode 3 may be parallel to the Z-axis direction.

The heater bracket 220 may be provided in plurality. For example, the right heater bracket 220a may be coupled to the right heater frame 210a. For example, the left heater bracket 220b may be coupled to the left heater frame 210b. The heater bracket 220 may include or mean at least one of the right heater bracket 220a or the left heater bracket 220b.

The right heater bracket 220a may be provided in plurality. For example, the right heater bracket 220a may include or mean at least one of an upper right bracket 220au and a lower right bracket 220ad. The upper right bracket 220au may be positioned above the lower right bracket 220ad.

The left heater bracket 220b may be provided in plurality. For example, the left heater bracket 220b may include or mean at least one of an upper left bracket 220bu and the lower left bracket 220bd. The upper left bracket 220bu may be positioned above the lower left bracket 220bd.

The heater unit 200 may include a heater 230. The heater 230 may be coupled or fixed to the heater bracket 220. The heater 230 may face the electrode 3. For example, the heater 230 may face the first electrode surface 3a (see FIG. 1) or the second electrode surface 3b (see FIG. 1). The heater 230 may heat the electrode 3.

The heater 230 may be provided in plurality. For example, the right heater 230a may be coupled or fixed to the right heater bracket 220a. For example, the left heater 230b may be coupled or fixed to the left heater bracket 220b. For example, the heater 230 may include or mean at least one of the right heater 230a or the left heater 230b.

The right heater 230a may include or mean at least one of an upper right heater 230au or a lower right heater 230ad. The upper right heater 230au may be coupled to the upper right heater bracket 220au. The lower right heater 230ad may be coupled to a lower right heater bracket 220ad.

The left heater 230b may include or mean at least one of an upper left heater 230bu or a lower left heater 230bd. The upper left heater 230bu may be coupled to the upper left heater bracket 220bu. The lower left heater 230bd may be coupled to the lower left heater bracket 220ad.

The right heater 230a can face the first electrode surface 3a (see FIG. 1) of the electrode 3. The left heater 230b can face the second electrode surface 3b (see FIG. 1) of the electrode 3.

The heater unit 200 may include a duct module 240. The duct module 240 may be adjacent to the electrode 3. The duct module 240 may be adjacent to the heater 230.

The duct module 240 can remove at least a portion of the air heated by the heater 230 and the electrode 3. The duct module 240 can prevent infrared rays generated from one of the two facing heaters 230 from reaching the other.

FIG. 7 is a drawing which shows the heater illustrated in FIG. 6. In FIG. 7, the heater 230 viewed from the electrode 3 (see FIG. 6) can be observed.

Referring to FIG. 7, the heater 230 may include a heater body 231. The heater body 231 may be coupled or fixed to the heater bracket 220 (see FIG. 6).

The heater 230 may include a heating segment 232. The heating segment 232 may be provided in plurality. The plurality of heating segments 232 may be arranged in the width direction. For example, the plurality of heating segments 232 may be arranged in the X-axis direction.

The heating segment 232 may emit, for example, a laser beam including infrared rays. For example, the heating segment 232 may include a laser cell that emits a laser beam. For example, the heating segment 232 may include a semiconductor laser cell or a diode laser cell.

For example, the plurality of heating segments 232 can be individually controlled. For example, the power of the plurality of heating segments 232 can be individually controlled.

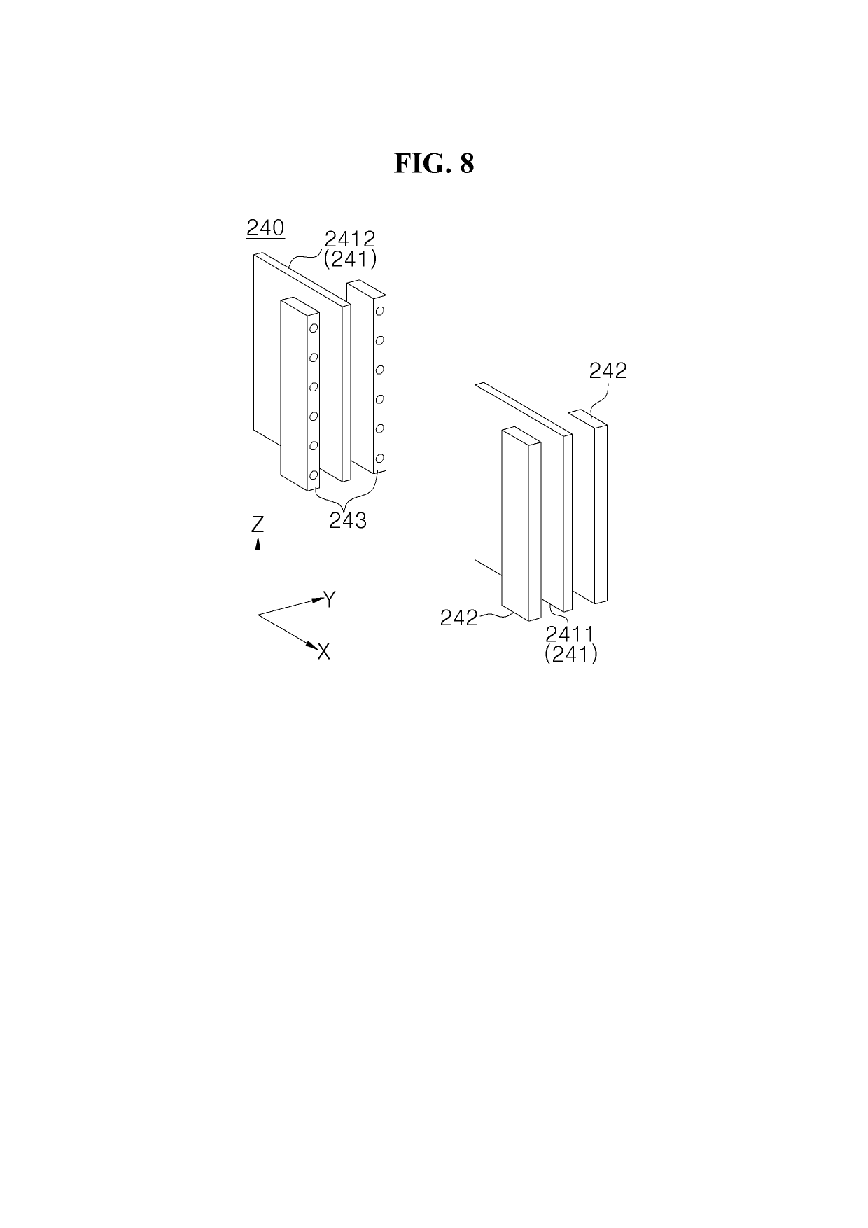

FIG. 8 is a drawing which shows the duct module illustrated in FIG. 6.

Referring to FIG. 8, the duct module 240 may include a shield frame 241. The shield frame 241 may be provided in plurality. For example, the duct module 240 may include a front shield frame 2411 and a rear shield frame 2412. The shield frame 241 may include or mean at least one of the front shield frame 2411 or the rear shield frame 2412.

The front shield frame 2411 and the rear shield frame 2412 can be spaced apart from each other. For example, the front shield frame 2411 may be positioned in front of the rear shield frame 2412. For example, the electrode 3 (see FIG. 6) can pass between the front shield frame 2411 and the rear shield frame 2412.

The shield frame 241 may face the side (or edge) of the electrode 3 (see FIG. 6). For example, the front shield frame 2411 may face a side (or an edge) of the electrode 3 (see FIG. 6), and the rear shield frame 2412 may face the other side (or the other edge) of the electrode 3 (see FIG. 6). The distance between the side and the other side of the electrode 3 (see FIG. 6) may be the width of the electrode 3 (see FIG. 6).

The shield frame 241 can be cooled by a refrigerant or the like. The shield frame 241 can be located between the right heater 230a (see FIG. 6) and the left heater 230b (see FIG. 6).

For example, the shield frame 241 can prevent infrared rays generated from the right heater 230a (see FIG. 6) from reaching the left heater 230b (see FIG. 6).

For example, the shield frame 241 can prevent infrared rays generated from the left heater 230b (see FIG. 6) from reaching the right heater 230a (see FIG. 6). As a result, overheating of the heater 230 (see FIG. 6) can be prevented.

The duct module 240 may include a blower segment 242 and an exhaust segment 243. The blower segment 242 and the exhaust segment 243 may be arranged in the width direction. For example, the blower segment 242 may be located in front of the exhaust segment 243. For example, the blower segment 242 may be located behind the exhaust segment 243.

The blower segment 242 and the exhaust segment 243 may be positioned between the heater 230 (see FIG. 6) and the shield frame 241. The space between the blower segment 242 and the exhaust segment 243 may be positioned between the electrode 3 (see FIG. 6) and the heater 230 (see FIG. 6).

The blower segment 242 can inject air (or gas) toward the exhaust segment 243. The exhaust segment 243 can suck in air (or gas). As a result, the heated air (or gas) can be removed.

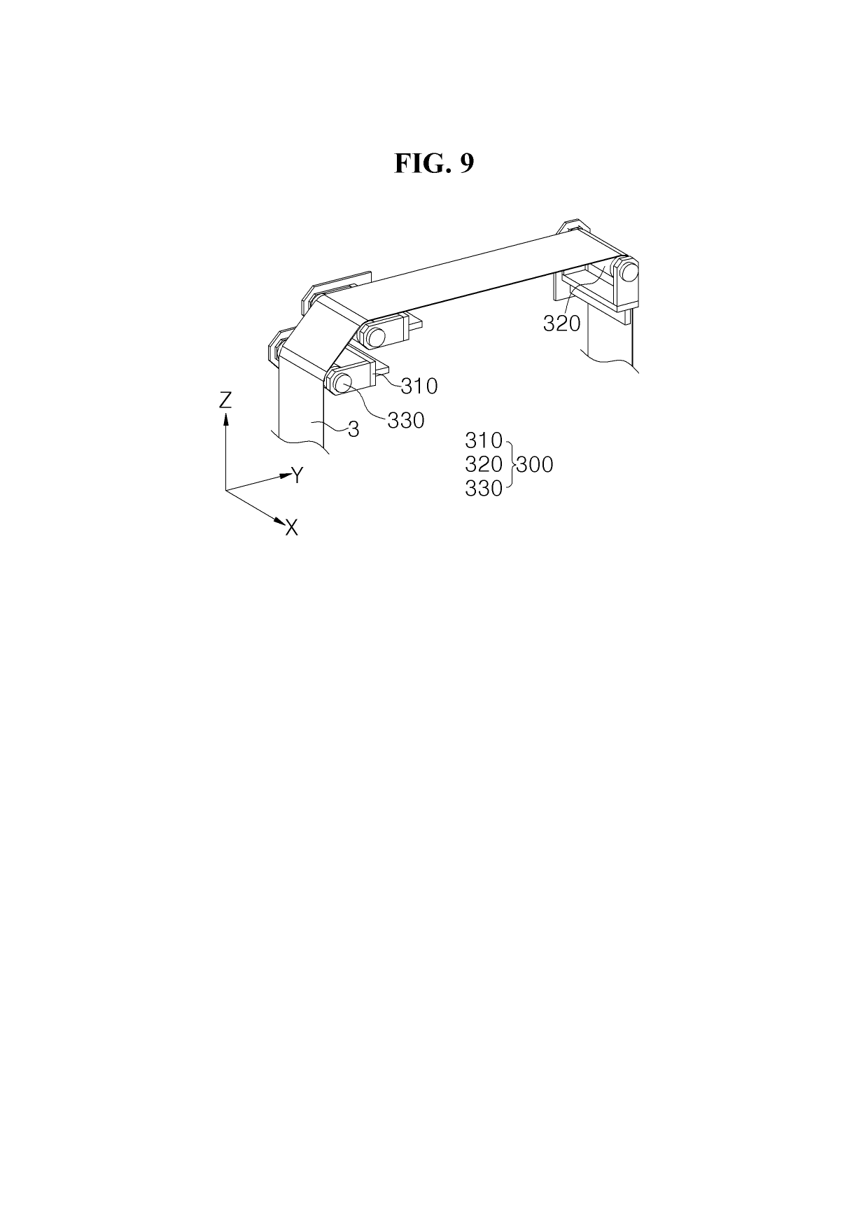

FIG. 9 is a drawing showing a heated electrode transport unit.

Referring to FIG. 9, the heated electrode transport unit 300 may include a heated electrode transport frame 310. The heated electrode transport frame 310 may be fixed to the external fixture.

The heated electrode transport unit 300 may include a heated electrode transport roller 320. The heated electrode transport roller 320 may have a roller shape. The heated electrode transport roller 320 may transport the electrode 3.

The heated electrode transport roller 320 can be rotatably coupled to the heated electrode transport frame 310. For example, the heated electrode transport roller 320 can rotate around the axis of the heated electrode transport roller 320.

The heated electrode transport unit 300 may include a heated electrode coolant supply portion 330. The heated electrode coolant supply portion 330 may transfer coolant supplied from the outside to the heated electrode transport roller 320. As a result, the heated electrode transport roller 320 may be cooled.

The heated electrode transport roller 320 can transport the electrode 3 heated by the heater assembly 200 (see FIG. 2). Therefore, the heated electrode transport roller 320 can be heated by the electrode 3.

When the heated electrode transport roller (320) is heated, the temperature of the heated electrode transport roller (320) may increase. When the temperature of the heated electrode transport roller 320 increases, the atmospheric temperature of the electrode drying facility 1 (see FIG. 2) may increase.

If the atmospheric temperature of the electrode drying equipment (1, see FIG. 2) rises, it may affect the electrode drying process. Therefore, it may be necessary to suppress the rise of the atmospheric temperature of the electrode drying facility 1 (see FIG. 2). The temperature rise of the heated electrode transport roller 320 can be suppressed by a coolant. The coolant provided to the heated electrode transport roller 320 may include water or oil.

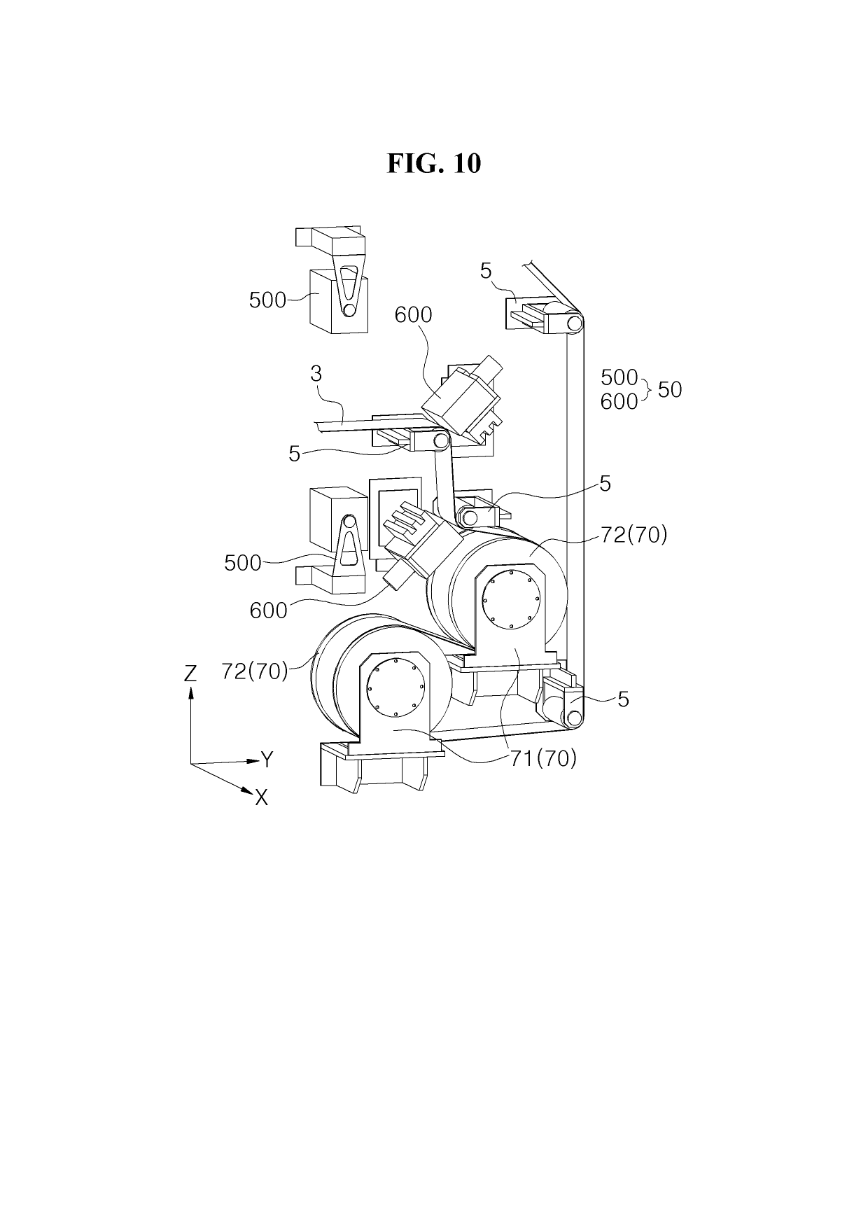

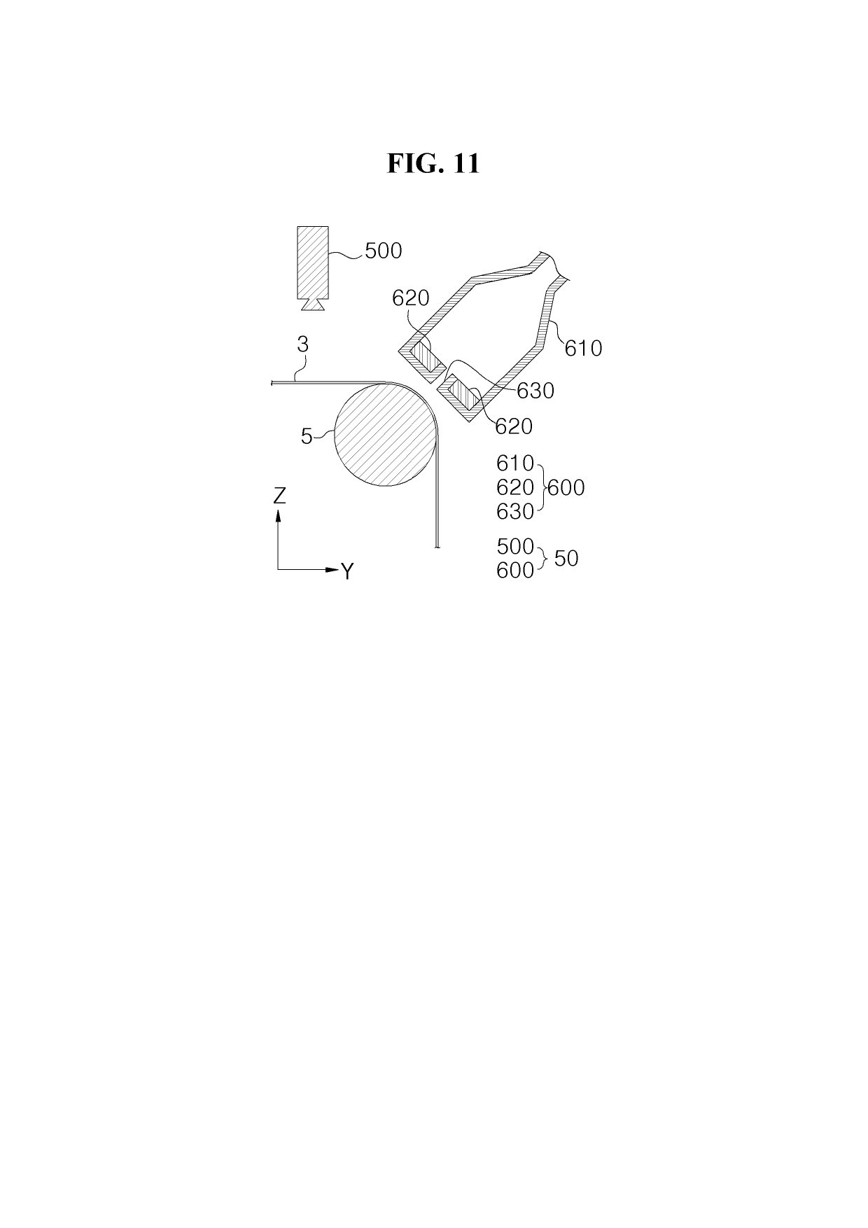

FIG. 10 is a drawing which shows an electrode cleaning equipment and an electrode cooling equipment according to an embodiment of the present disclosure. FIG. 11 is a drawing which shows a cross-section of a part of the electrode drying facility shown in FIG. 10.

Referring to FIGS. 10 and 11, the electrode 3 can be transported by the transport roller assembly 5. The transport roller assembly 5 can include a plurality of rollers.

The electrode cleaning equipment 50 may include a discharge device 500. The discharge device 500 may remove at least a portion of the static electricity formed on the electrode 3.

The electrode cleaning equipment 50 may include a suction device 600. The electrode 3 from which at least a portion of static electricity has been removed by the discharge device 500 may be transported toward the suction device 600.

The suction device 600 may include a suction body 610. The suction body 610 may form a space inside. A suction nozzle 630 may be coupled or formed at an end of the suction body 610. The other end of the suction body 610 may be connected to the outside. For example, the other end of the suction body 610 may be connected to a vacuum pump (not shown).

The suction device 600 may include an ultrasonic generator 620. The ultrasonic generator 620 may be connected or coupled to the suction body 610. The ultrasonic generator 620 may provide ultrasonic waves to the electrode 3.

When ultrasonic waves are applied to the electrode 3, the electrode 3 can vibrate. When the electrode 3 vibrates, foreign substances (dust, etc.) attached to the electrode 3 can be separated from the electrode 3. The foreign substances can be sucked into the interior of the suction body 610 through the suction nozzle 630 facing the electrode 3. The foreign substances sucked into the interior of the suction body 610 can move toward a vacuum pump (not shown).

The discharge device 500 may be provided as a pair. One of the pair of discharge devices 500 may face the first electrode surface 3a (see FIG. 1). The other of the pair of discharge devices 500 may face the second electrode surface 3b (see FIG. 1).

The suction device 600 may be provided as a pair. One of the pair of suction devices 600 may be face the first electrode surface 3a (see FIG. 1). The other of the pair of suction devices 600 may be face toward the second electrode surface 3b (see FIG. 1).

The electrode cooling equipment 70 may include an electrode cooling frame 71. The electrode cooling frame 71 may be fixed to the outside. The electrode cooling equipment 70 may include an electrode cooling roller 72.

The electrode cooling roller 72 may form a roller shape. The electrode cooling roller 72 can be rotatably coupled to the electrode cooling frame 71. For example, the electrode cooling roller 72 can rotate around the axis of the electrode cooling roller 72.

The electrode 3 from which foreign substances have been separated by the electrode cleaning equipment 50 can be transported to the electrode cooling equipment 70. The electrode cooling roller 72 can be cooled by a refrigerant or the like.

The temperature of the electrode cooling roller 72 may be, for example, lower than the temperature of the electrode 3 in contact with the electrode cooling roller 72. Therefore, the electrode cooling roller 72 can cool the electrode 3.

The electrode cooling equipment 70 may be provided as a pair. For example, the electrode cooling roller 72 of one of the pair of electrode cooling equipment 70 may be in contact with the first electrode surface 3a (see FIG. 1). For example, the electrode cooling roller 72 of the other of the pair of electrode cooling equipment 70 may be in contact with the second electrode surface 3b (see FIG. 1).

The above description is merely an example of applying the principles of the present disclosure, and other configurations may be further included without departing from the scope of the present disclosure.

What is claimed is:

1. An electrode drying facility for transporting and drying an electrode extended in the longitudinal direction, comprising:
a heating roller unit including a heating roller that forms a roller shape and transports the electrode and heats the electrode;
a heater unit heating the electrode drawn from the heating roller unit;
an electrode cooling equipment cooling the electrode drawn from the heater unit,
wherein the heater unit irradiates a laser beam containing infrared rays to the electrode.

2. The electrode drying facility of claim 1, wherein the heater unit includes:
a first heater assembly heating the electrode drawn from the heating roller; and
a second heater assembly heating the electrode drawn from the first heater assembly according to a temperature of the electrode drawn from the first heater assembly.

3. The electrode drying facility of claim 2, further comprising:
a sensor unit measuring the temperature of the electrode; and
a control unit,
wherein the sensor unit measures the temperature of the electrode drawn from the first heater assembly, and
wherein the control unit controls a power of the second heater assembly according to the temperature of the electrode.

4. The electrode drying facility of claim 3, wherein the second heater assembly includes:
a heater frame;
a heater bracket coupled to the heater frame; and
a heater coupled to the heater bracket,
wherein the heater includes:
a heater body coupled to the heater bracket; and
a plurality of heating segments coupled to the heater body and arranged in a width direction of the electrode and irradiating infrared rays.

5. The electrode drying facility of claim 4, wherein the sensor unit measures the temperature distributed in the width direction of the electrode,
wherein the control unit controls the plurality of heating segments according to the temperature distributed in the width direction of the electrode.

6. The electrode drying facility of claim 4, wherein the heater bracket is movably coupled to the heater frame in at least one of the longitudinal direction or the width direction.

7. The electrode drying facility of claim 1, further comprising a heated electrode transport unit transporting the electrode drawn from the heater unit,
wherein the heated electrode transport unit includes:
a heated electrode transport frame;
a heated electrode transport roller rotatably coupled to the heated electrode transport frame and being in contact with the electrode; and
a heated electrode coolant supply portion supplying a coolant to the heated electrode transport roller.

8. The electrode drying facility of claim 1, further comprising an electrode cleaning equipment that removes foreign substances attached to the electrode drawn from the heater unit and transfers the electrode to the electrode cooling equipment.

9. The electrode drying facility of claim 8, wherein the electrode cleaning equipment includes:
a discharge device removing at least a portion of the static electricity formed on the electrode; and
a suction device removing at least a portion of the foreign substances from the electrode.

10. The electrode drying facility of claim 9, wherein the suction device includes:
a suction nozzle facing the electrode;
a suction body forming a hollow portion; and
an ultrasonic generator irradiating an ultrasonic wave on the electrode, and
wherein an end of the suction body is connected to the suction nozzle.

11. The electrode drying facility of claim 1, wherein the heater unit includes:
a heater frame;
a heater bracket coupled to the heater frame;
a heater coupled to the heater bracket; and
a duct module positioned adjacent to the electrode,
wherein the duct module includes:
a blower segment blowing a gas; and
a exhaust segment facing the blower segment and sucking the gas.

12. The electrode drying facility of claim 1, wherein the heater unit includes:
a right heater and a left heater which face the electrode, the electrode being placed between the right heater and the left heater; and
a shield frame placed between the right heater and the left heater.

13. The electrode drying facility of claim 12, wherein the shield frame includes a front shield frame and a rear shield frame spaced apart from each other,
wherein the electrode is placed between the front shield frame and the rear shield frame,
wherein the front shield frame faces a side of the electrode; and
wherein the rear shield frame faces the other side of the electrode.

14. An electrode drying method for transporting and drying an electrode extended in a longitudinal direction, comprising:
heating the electrode;
cleaning the electrode by removing foreign substances from the heated electrode; and
cooling the electrode.

15. The method of claim 14, wherein heating the electrode includes:
heating the electrode firstly;
acquiring information on a temperature of the electrode; and
heating the electrode secondly according to the information on the temperature of the electrode.

16. The method of claim 15, wherein the information on the temperature of the electrode includes a temperature distribution in a width direction of the electrode.

17. The method of claim 15, wherein heating the electrode includes preheating the electrode before heating the electrode firstly.

18. The method of claim 17, wherein the temperature of the electrode after preheating the electrode before heating the electrode firstly is lower than the temperature of the electrode after heating the electrode firstly before heating the electrode secondly.

19. The method of claim 17, wherein preheating the electrode is performed through heat conduction, wherein heating the electrode firstly is performed through heat radiation, and wherein heating the electrode secondly is performed through the heat radiation.

20. The method of claim 14, wherein cleaning the electrode includes:
removing at least a portion of static electricity formed on the electrode;
irradiating an ultrasonic wave on the electrode; and
sucking the foreign substances.
